(19) United States
(12) Patent Application Publication
(10) Pub. No.: US 2013/0141765 A1
(43) Pub. Date: Jun. 6, 2013

(54) Secure Printable Offer Template

(71) Applicant: VALASSIS COMMUNICATIONS, INC., Livonia, MI (US)

(72) Inventors: Richard Rutt, Farmington Hills, MI (US); Rinaldo DiGiorgio, Easton, CT (US)

(73) Assignee: VALASSIS COMMUNICATIONS, INC., Livonia, MI (US)

(21) Appl. No.: 13/688,889

(22) Filed: Nov. 29, 2012

Related U.S. Application Data
(60) Provisional application No. 61/565,788, filed on Dec. 1, 2011.

(51) Int. Cl. G06Q 30/02; G06K 15/02

(52) U.S. Cl. CPC G06Q 30/0225; G06K 15/02
USPC 358/3.28; 358/1.18

(57) ABSTRACT

An offer template for use in generating print-at-home offer documents includes a number of content layers including a canvas layer, an offer layer and a reference layer. The canvas layer includes content common to several different offers. The offer layer includes offer-specific content. The reference layer includes print-specific content uniquely identifying each printed offer document. The offer template further includes a number of security attributes designed to reduce fraudulent activity involving distributed offers, such as unauthorized copying, manipulating or reproducing of print-at-home offers.

### CROSS-REFERENCE TO RELATED APPLICATIONS

This application claims the benefit of U.S. provisional Application No. 61/565,788 filed Dec. 1, 2011, the disclosure of which is incorporated in its entirety by reference herein.

### TECHNICAL FIELD

The present application relates to a secure offer template for online offers that may be printed by a consumer using a printing device and a personal computing device.

### BACKGROUND

More and more offer distributers are making offers available to consumers online as an alternative and/or supplement to direct mailing and other forms of marketing. In an online system, consumers may select desired offers to be printed using a printing device in communication with the consumer's personal computer device. These offers may be referred to as print-at-home offers. These print-at-home offers can be susceptible to unauthorized copying, manipulation, reproduction or other fraudulent use.

### SUMMARY

The present application describes an exemplary, digital offer template used to generate print-at-home offer documents. The offer template may include a number of security attributes designed to reduce fraudulent activity involving print-at-home offers. According to one or more embodiments of the present application, the offer template may include a canvas content layer, an offer content layer, and a reference content layer. The canvas content layer may include attributes common to a plurality of offer documents. The offer content layer may include a number of offer-specific content elements. The reference content layer may include a number of print-specific content elements configured to uniquely identify each printed offer document. The reference content layer, having print-specific information, may be merged with the canvas content layer and the offer content layer at the time of printing to generate a printable offer document.

One or more additional embodiments of the present application are directed to a method for distributing printable offers. The method may include formatting offer data for display on an electronic display device and storing a digital offer template for use in generating a plurality of printable offer documents. The digital offer template may include a canvas content layer including attributes common to the plurality of printable offer documents and an offer content layer including offer-specific content based on the offer data. The digital offer template may further include a reference content layer including a number of print-specific content elements for uniquely identifying each printed offer document. The method may further include receiving input from a client device indicative of a request to print an offer document corresponding to the offer data, inserting print-specific content into the reference content layer based on the input, and generating a printable offer document in response to the input by merging the reference content layer with the canvas content layer and the offer content layer. Thereafter, the method may further include outputting the printable offer document for printing on a printing device in communication with the client device.

One or more additional embodiments of the present application are directed to an offer distribution system including an offer management system having at least one server and at least one database in communication with each other. The offer management system may be connectable to a network for communicating with a plurality of client devices. The at least one server may include a microprocessor configured to format offer data for display on an electronic display device and store a digital offer template for use in generating a plurality of printable offer documents. The digital offer template may include a canvas content layer including attributes common to the plurality of printable offer documents and an offer content layer including offer-specific content based on the offer data. The digital offer template may further include a reference content layer including a number of print-specific content elements for uniquely identifying each printed offer document. The microprocessor may be further configured to receive input from a client device indicative of a request to print an offer document corresponding to the offer data and generate a printable offer document based on the input by merging the reference content layer including print-specific content with the canvas content layer and the offer content layer.

### BRIEF DESCRIPTION OF THE DRAWINGS

FIG. 1 is an exemplary view of an offer document generated using an offer template according to one or more embodiments of the present application;

FIG. 2a is an exemplary view of a canvas layer of an offer template according to one or more embodiments of the present application;

FIG. 2b is an exemplary view of an offer layer added to the canvas layer depicted in FIG. 2a according to one or more embodiments of the present application;

FIG. 2c is an exemplary view of a reference layer added to the canvas layer and offer layer depicted in FIG. 2b according to one or more embodiments of the present application;

FIG. 3 is an enlarged view depicting a security strip content field according to one or more embodiments of the present application;

FIG. 4 is an enlarged view of an offer border according to one or more embodiments of the present application;

FIG. 5 is an enlarged view of an expiration date content field according to one or more embodiments of the present application;

FIG. 6a-c are enlarged views of exemplary savings value statement content fields according to one or more embodiments of the present application;

FIG. 7a is an enlarged view of an end portion of an offer template according to one or more embodiments of the present application;

FIG. 7b is an enlarged view of a watermark element contained in the end portion depicted in FIG. 7a; and

FIG. 8 is a block diagram of an online offer distribution system for use in providing print-at-home offers, in accordance with one or more embodiments of the present application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

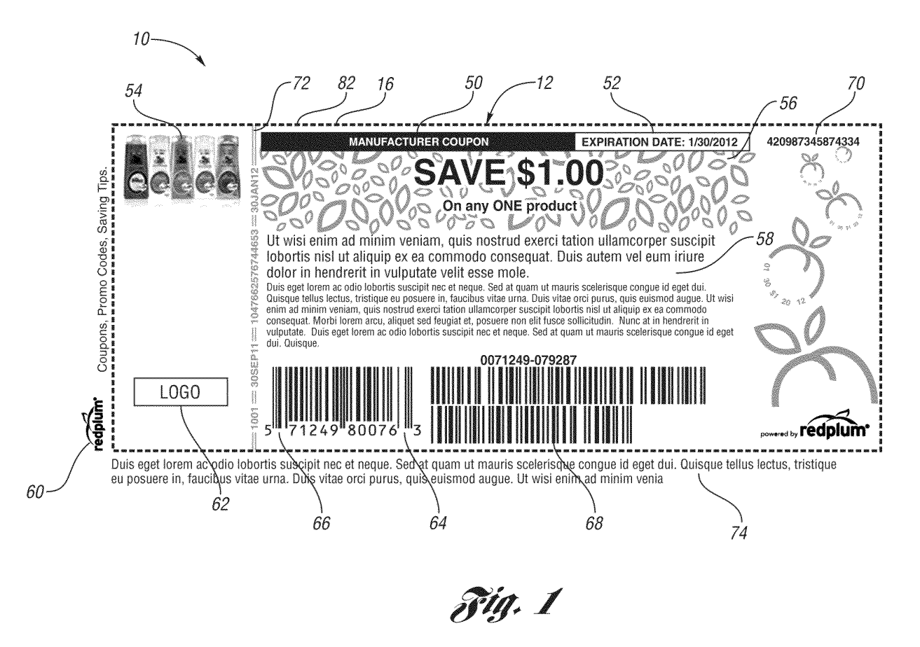

FIG. 1 depicts an exemplary offer document 10 generated using an offer template 12 and offer data. The composition of the offer template 12 may include attributes and elements to enhance offer security. The attributes of the offer template 12 are designed to prevent, deter and/or identify fraudulent use of distributed offers, including unauthorized copying or reproducing of printed offers. As used herein, an offer may include coupons, rebates, promotions, vouchers, discounts, or any other similar incentives. Offer data generally corresponds to data associated with a particular offer. Some or all of the offer data may be received from an offer provider when defining the offer. Additionally or alternatively, the offer data may be generated by an offer management and distribution system from input criteria received from an offer provider defining the offer. An offer provider may include any source of offers. Exemplary offer providers may include a consumer packaged goods (CPG) entity, a manufacturer, a retailer, a service provider, a syndicated source, an advertiser, a restaurant, or the like. An offer document may generally refer to an offer fixed in a tangible medium including, for example, printing on paper. However, an offer document may also refer to an offer displayed on an electronic display using the offer template 12.

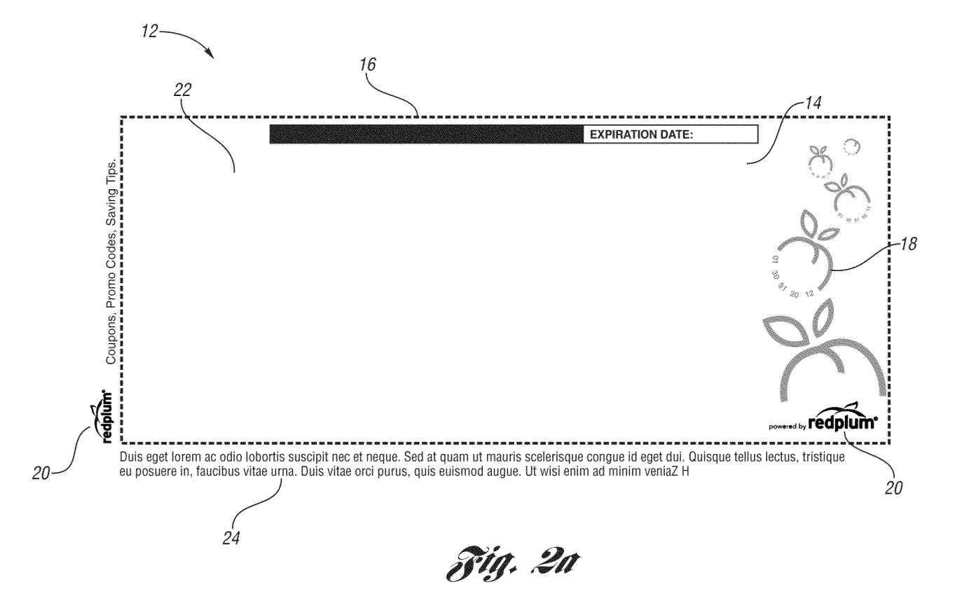

The offer template 12 may be composed of a number of layers. According to one or more embodiments of the present application, the offer template 12 may include a canvas layer, an offer layer and a reference layer. FIG. 2a depicts an exemplary canvas layer 14 of an offer template 12. As shown in FIG. 2a, the canvas layer 14 may be a base layer with attributes common to all offer documents. For instance, the canvas layer 14 may include an offer border 16, watermarks 18 and logos 20 common to all offer documents, blank fields 22 for containing offer specific information, restriction and legal implication statements 24, and the like. With reference to FIG. 2b, the exemplary offer template 12 is shown with an offer layer 26 added to the canvas layer 14. The offer layer 26 may include a number of offer-specific elements. According to one or more embodiments, the number of offer-specific elements may include an offer type indicator 28, a product image 30 associated with the offer, an offer provider or brand logo 32, a savings value statement and offer description 34, offer instructions 36, one or more machine-readable codes 38 (e.g., barcodes), and the like.

As shown in FIG. 2c, an exemplary reference layer 40 may be added to or otherwise combined with the canvas layer 14 and offer layer 26. The reference layer 40 may include unique identification attributes for a specific offer document or impression. For example, the reference layer 40 may include a unique offer identification number 42, unique encrypted offer information 44, timestamps, and the like. The unique offer identification number 42 may be unique to an offer document. Thus, each offer document printed may contain a unique offer identification number. The unique offer identification number 42 may be human readable. Additionally or alternatively, an offer document timestamp may be embedded within the unique offer identification number 42. The timestamp may correspond to the date and time the associated offer document was printed, the time a print request was received, or the like. Moreover, when the reference layer 40 is applied to the offer template 12 at the time of printing to generate the offer document 10, the barcode or other machine-readable data may be updated to include the expiration date and the unique offer identification number 42. Accordingly, the offer template 12 may be used to generate an offer document containing redundant offer information that is provided in both encrypted and unencrypted form. For example, the unique offer identification number 42 may be contained within the offer document 10 in an unencrypted, human readable form as well an encrypted, machine-readable form.

The unique encrypted offer information 44 may be applied to an offer template as a security strip 46, which is described in greater detail below. The reference layer 40 may further include an expiration date 48, which is also described in greater detail below. The expiration date 48 may be based on a rolling time period (e.g., days, months, etc.) from when the offer document is printed. Since FIG. 2c depicts the merger of the canvas layer 14, the offer layer 26 and the reference layer 40 to generate an exemplary offer document 10, FIG. 2c is similar to FIG. 1.

With reference back to FIG. 1, the composition of the offer template 12 for generating print-at-home offers will be described in greater detail. The offer template 12 may include content fields, elements and attributes that generally appear in every offer document 10. The content fields may be generally reserved for offer-specific and/or print-specific information, although some content fields may be common among several, if not all, offers. When a print request for a particular offer selected by a consumer is received, the offer template 12 may be populated with offer-specific information contained in the offer data as well as offer reference information (e.g., the unique offer identification number). As a result, an offer document may be printed using a printing device in communication with a personal computing device used by the consumer to view print-at-home offers displayed online.

As shown in FIG. 1, the offer template 12 may include a number of content fields including, for example, an offer type content field 50, an expiration date content field 52, a product image content field 54, a savings value statement content field 56, an offer instructions content field 58, and the like. The offer type content field 50 may include information indicating the type of offer and/or identify the type of offer provider. For instance, the offer type content field 50 may indicate whether the offer is a manufacturer offer, a retailer offer, or the like. The expiration date content field 52 may be populated with an expiration date for the printed offer document. As previously described, the expiration date may be based on the print date of the offer document if, for example, a rolling time period is to be applied. Alternatively, the expiration date may be a fixed date based on the specific offer as defined by the offer provider.

The product image content field 54 may include one or more images depicting a product or service to which the offer relates. The savings value statement content field 56 may include text conveying a description of the offer and/or a value associated with the offer. The offer instructions content field 58 may include consumer instructions and/or retailer instructions concerning the offer.

Additional content fields associated with the offer template 12 may include an external logo content field 60, an internal logo content field 62, and a number of barcode content fields 64. The external logo content field 60 may include a brand logo associated with an online offer distributor or offer provider. Moreover, the external logo content field 60 may include a brand tagline. The internal logo content field 62 may include a brand logo associated with the product to which the offer relates. In this regard, the internal logo content field 62 may include a brand logo associated with a manufacturer, a CPG entity, or the like. According to one or more embodiments of the present application, the number of barcode content fields 64 may include a primary barcode content field 66 and a secondary barcode content field 68. The primary and secondary barcode content fields may be populated using any barcode type, such as UPC, EAN, GS1 and the like. The barcode content fields 64 may include encrypted, machine readable offer information. Additionally, as previously described, at least one of the barcodes in the barcode content fields 64 may be updated with the unique offer identification number 42 and/or timestamp. In addition to or instead of the barcode content fields 64, the offer template 12 may include one or more other content fields for containing machine-readable code.

The offer template 12 may also include a human readable ID content field 70, a security strip content field 72, and a legal text content field 74. The human readable ID content field 70 may contain the unique offer identification number 42 in human readable form. For instance, the unique offer identification number 42 may be displayed using alphanumeric characters. As previously described, the unique offer identification number 42 may include a timestamp indicative of the date and time the offer document 10 was printed or requested to be printed. According to one or more embodiments, the timestamp may be embedded within the unique offer identification number 42 as a Julian date.

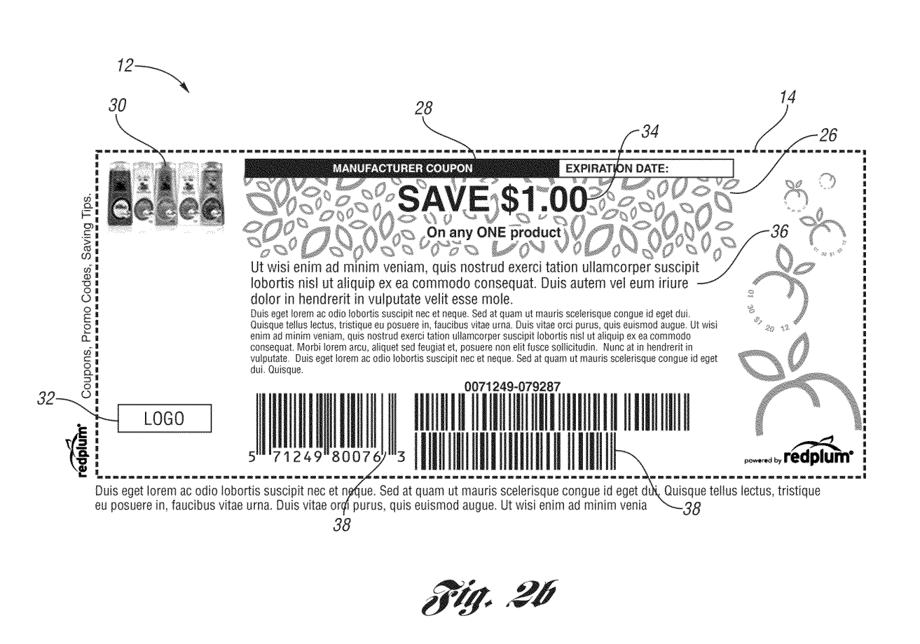

The security strip content field 72 may be a relatively thin vertical or horizontal strip for containing unique encrypted or unencrypted offer information. FIG. 3 depicts an enlarged view of an exemplary security strip content field 72 according to one or more embodiments of the present application. As seen therein, the security strip content field 72 may be populated with the offer information using a string of symbols and alphanumeric characters. The string may or may not include blank characters. The security strip content field 72 may contain one or more of the following information items: an offer ID 76, a print date 78, the unique offer identification number 42, the offer expiration date 48, and the like. Unlike the unique offer identification number 42, which is unique to each offer document, the offer ID 76 may be a general identifier for a particular offer. The security strip content field 72 may extend from the offer border 16 on one side of the offer document 10 to the offer border 16 on an opposite side of the offer document. Additionally, the security strip content field 72 may align with gaps 80 in the offer border 16 (e.g., a space in between dashes, dots or similar border elements). The offer information contained in the security strip content field 72 may be printed in a certain color that is suppressed when it is photocopied using a black and white photo copier (e.g., Cyan). Accordingly, an unauthorized copy of a print-at-home offer may be spotted by retailers and the like.

Referring back to FIG. 1, the legal text content field 74 may contain information that does not necessarily provide direct security to the offer document 10, but may nevertheless indirectly provide a heightened sense of awareness to consumers of the legal implications for fraudulent practices involving the offer document. Thus, the information contained in the legal text content field 74 may act as a general deterrent to unauthorized use of the offer.

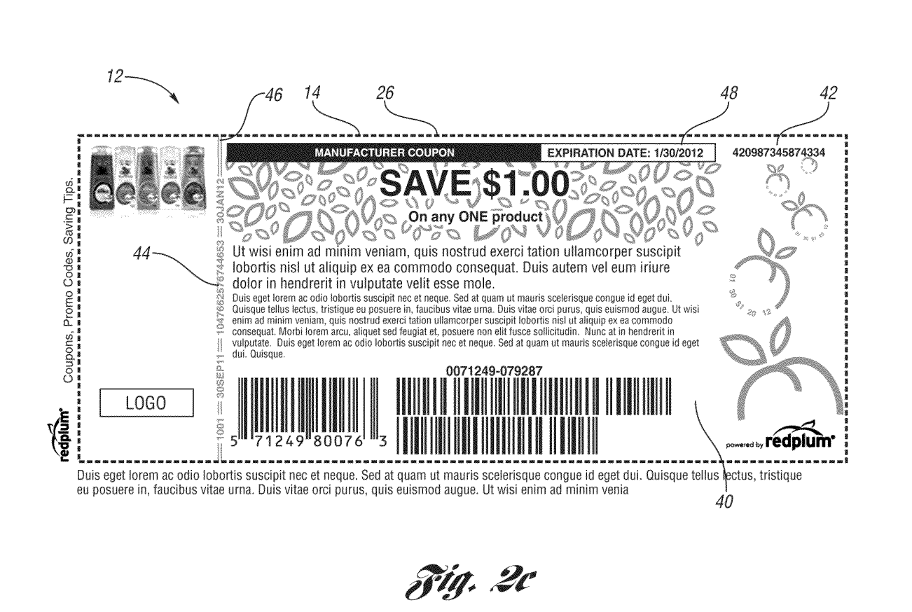

In addition to the content fields described above, the offer template 12 may include other attributes and elements contributing to the security of an offer document from unauthorized reproduction or manipulation. For example, the offer border 16 of the offer template 12 generally defines the perimeter of a corresponding offer document. To enhance the security of a printed offer document, the offer border 16 may include a unique pattern of border elements 82. Variations to the pattern of border elements 82 may go undetected by the naked eye. FIG. 4 depicts an enlarged portion of the offer border 16 according to one or more embodiments of the present application. As shown in FIG. 4, the offer border 16 may be generally composed of a pattern of dashes, although other border elements may be used. Upon ordinary observation using the naked eye, the pattern appears to be a repetitive sequence of border elements (e.g., dashes) having the same dimension and spacing. However, according to one or more embodiments of the present application, select border elements 82 may vary slightly in dimension so as to be indiscernible to a typical observer. Additionally, spacing between the border elements 82 may be slightly varied in certain or limited locations so as to also be indiscernible to the naked eye. Further, the border elements 82 (e.g., dashes) employed to generate the offer border 16 may be characters selected from a non-standard character format that is unavailable through standard software applications.

Another generally indiscernible security attribute of the offer template 12 may include the general use of unique, non-standard fonts in one or more of the content fields containing alphanumeric text. As with the offer border 16, the non-standard font may not be available through standard software applications. However, the non-standard font may be similar to a standard font available in most software applications. Accordingly, the variation between the non-standard font and standard font may be undetectable to the ordinary observer, but may be differentiated upon close inspection to identify manipulated offer documents.

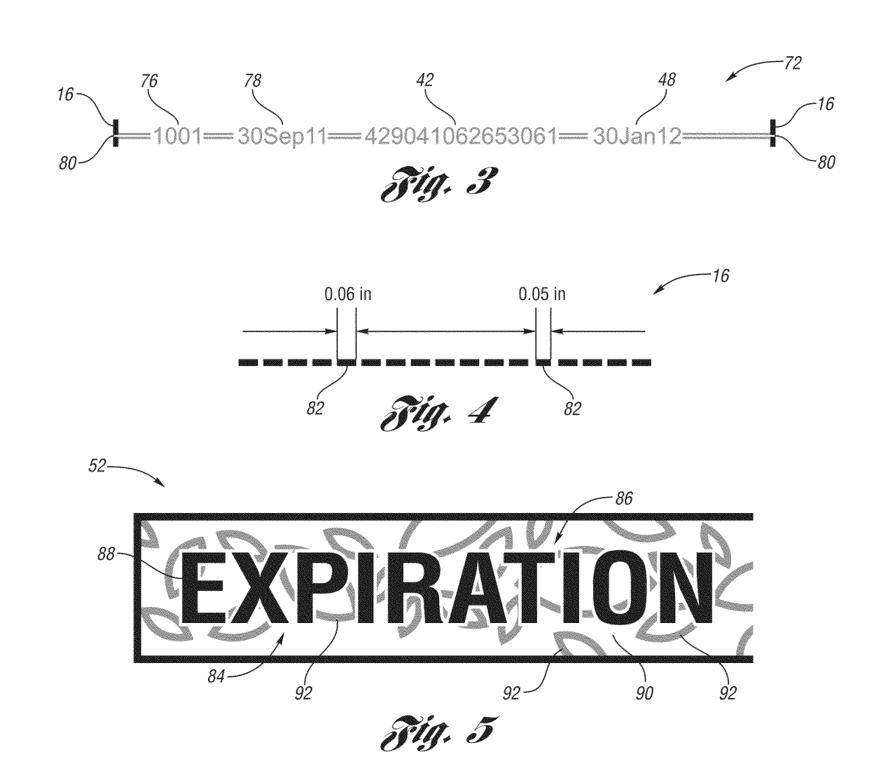

FIG. 5 depicts yet another generally indiscernible security feature of the offer template 12. The security feature may be contained in a content field having at least a first indicia 84 and a second indicia 86. The first indicia 84 may include at least two alphanumeric characters. The second indicia 86 may include at least one indiscernible attribute applied to the first indicia 84. According to one or more embodiments of the present application, the at least one indiscernible attribute may include: (a) a variation in the spacing between alphanumeric characters; (b) a variation in font type between alphanumeric characters; and (c) a variation in font size between alphanumeric characters. The variation applied to the first indicia 84 may be slight enough to be generally indiscernible during ordinary observation with the human eye, yet may be detected upon close inspection. As an example, FIG. 5 provides an enlarged view of a portion of the expiration date content field 52. As seen therein, the size of the font in the expiration date label 88 may vary ever so slightly between two or more alphanumeric characters. In the particular example shown, the letters “P” and “R” may be a ½ font size larger than the other characters. This variation in font size is not detectible to the naked eye, but can assist in the identification of a manipulated or otherwise fraudulently reproduced offer document.

The offer template 12 may employ the use of a number of distinct watermarks. As shown in FIG. 5, a watermark 90 may be provided in the background of a particular content field. The watermark 90 may include a plurality of watermark elements 92. The plurality of watermark elements 92 may vary in size, shape, color, and/or color depth/intensity. Further, the spacing between the watermark elements may also vary so as to form an irregular pattern of watermark elements. This irregular pattern can make unauthorized replication more challenging.

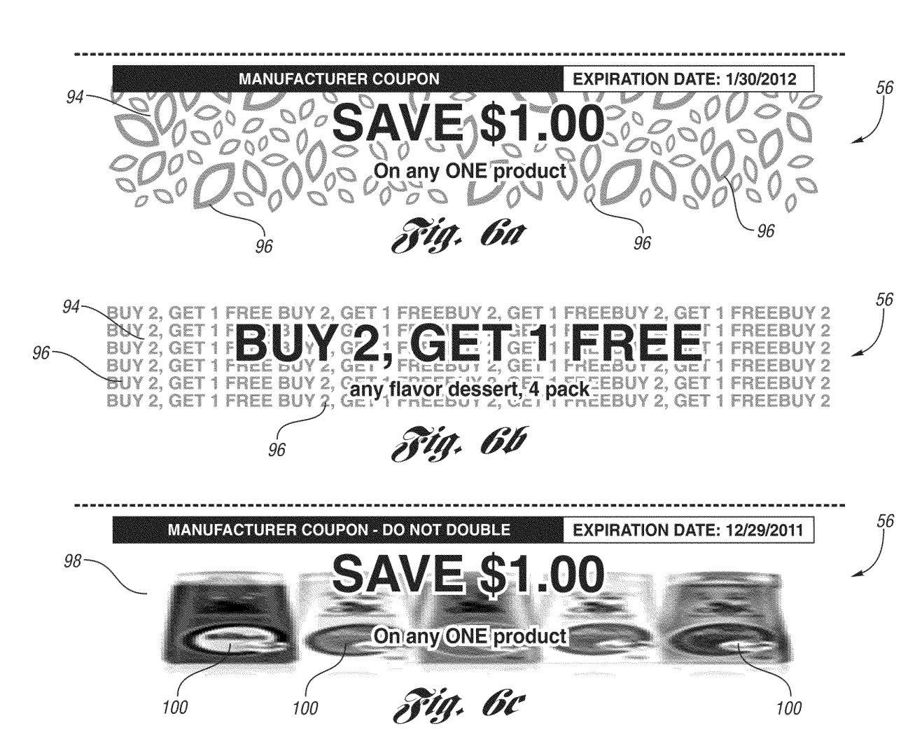

FIGS. 6a-6c provide another example of watermarks that may be generated in a content field within an offer document. In this example, FIGS. 6a-6c depict enlarged views of the savings value statement content field 56. However, the watermark attributes described with reference to FIGS. 6a-6c may be provided elsewhere in the offer template 12. The savings value statement content field 56 may also contain a watermark 94 composed of a number of watermarks elements 96. As shown in FIG. 6a, the watermark elements 96 may be images of objects. Similar to FIG. 5, the watermark elements 96 may vary in size, shape, color, and/or color depth/intensity. The watermark 94 shown in FIG. 6a may be a default watermark used in the offer template 12 when an offer-specific watermark is not designated. The offer template 12 may utilize one of several default watermarks. For instance, as shown in FIG. 6b, the watermark elements 96 may be smaller versions of the savings value statement taken from the foreground and applied repeatedly in the background of the content field as a watermark. Alternatively, FIG. 6c shows an offer-specific watermark 98 composed of watermark elements 100 associated with the offer. For example, the watermark elements 100 may be a product image or an offer provider logo. Offer providers may have the option of designating whether an offer document is generated with the offer-specific watermark 98. If no such designation is made, a default watermark may be used instead.

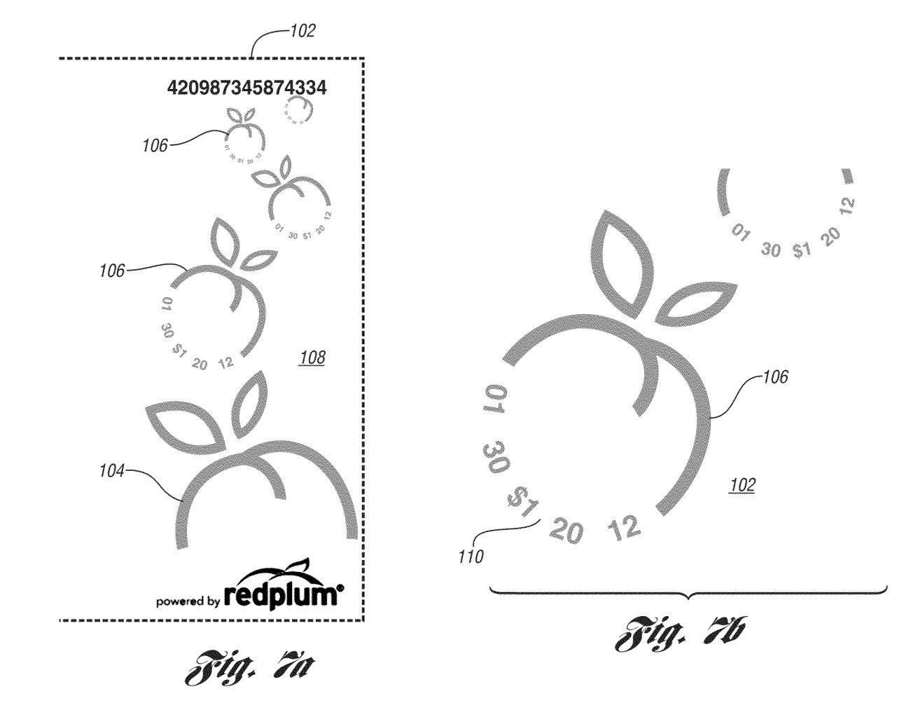

FIG. 7a depicts an enlarged view of an end portion 102 of the offer template 12 having additional security attributes according to one or more embodiments of the present application. As seen therein, the offer template 12 may include yet another watermark 104 composed of a plurality of watermark elements 106. The watermark elements 106 may be any suitable image for use as a watermark including, for example, a logo or similar object. The watermark elements 106 may be applied as cascading objects, as shown, although other patterns may also be utilized. The watermark elements 106 may vary in size. Moreover, the watermark elements 106 may also be generated with varying levels of color depth or intensity that will distort the watermark image when photocopied using standard settings. In the example shown in FIG. 7a, each watermark element 106 is a plum, however, the plurality of watermark elements may include alternative object images. Additionally, the watermark 104 generated at the end portion of the offer template 12 may be accented by a gradient color pattern in the background 108. Other portions of the offer template 12 may also include a gradient color pattern to make replication and copying difficult.

According to one or more embodiments of the present application, at least one of the watermark elements 106 may be contain data about the offer document 10 embedded into a feature of the watermark element. FIG. 7b is an enlarged view of a watermark element 106 containing such offer data. The offer data may be a string of alphanumeric characters 110 contained within a pattern that does not appear readable to the human eye. Under ordinary observation, the string of alphanumeric characters 110 may appear the same as similar pattern in the other watermark elements. As shown in FIG. 7b, the alphanumeric string of offer data may form a portion of the outer edge of the watermark element 106 (e.g., the plum). The offer data embedded into the watermark element 106 may include the expiration date and/or the offer value. However, alternate information relating to the offer document may be embedded within a feature of the watermark element 106. Although these additional security attributes are shown on the end portion 102, they may be provided at alternate locations of the secure offer template as well.

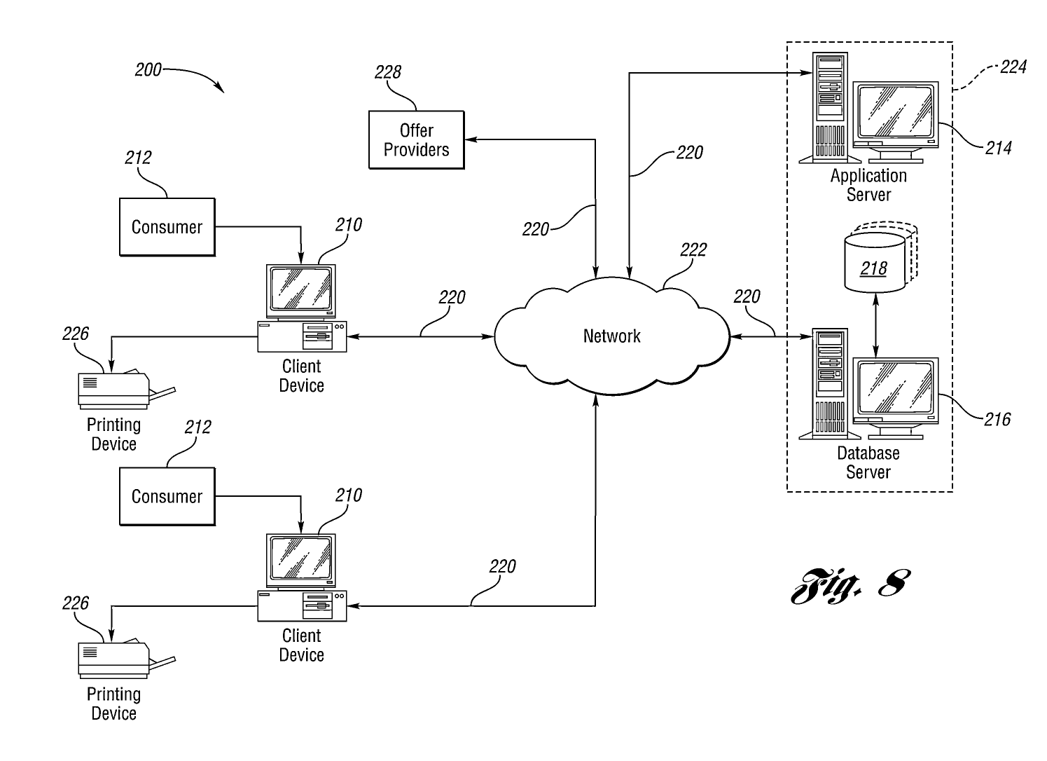

FIG. 8 is a high-level block diagram of an exemplary online offer distribution system 200 for providing print-at-home offers to online consumers. In one embodiment, the offer distribution system 200 can be implemented as a networked client-server communications system. To this end, the system 200 may include one or more client computing devices 210 for use by consumers 212, one or more application servers 214, and one or more database servers 216 connected to one or more databases 218. Each of these devices may communicate with each other via a connection to one or more communications channels 220. The communications channels 220 may be any suitable communications channels such as the Internet, cable, satellite, local area network, wide area networks, telephone networks, or the like. Any of the devices described herein may be directly connected to each other and/or connected over one or more networks 222. While the application server 214 and the database server 216 are illustrated as separate computing devices, an application server and a database server may be combined in a single server machine. Moreover, the application server 214, database server 216 and databases 218 may form part of an offer management system 224.

One application server 214 may provide one or more functions or services to the client devices 210. Accordingly, each application server 214 may be a high-end computing device having a large storage capacity, one or more fast microprocessors, and one or more high-speed network connections. One function or service provided by the application server 214 may be a web application, and the components of the application server may support the construction of dynamic web pages.

One database server 216 may provide database services to the application server 214, the client devices 210, or both. Information stored in the one or more databases 218 may be requested from the database server 216 through a “front end” running on a client device 210, such as a web application for viewing offers and printing selected offer documents. On the back end, the database server 216 may handle tasks such as data analysis and storage.

Relative to a typical application server 214 or database server 216, each client device 210 may typically include less storage capacity, less processing power, and a slower network connection. For example, a client device 210 may be a personal computing device, personal digital assistant (PDA), mobile phone and/or any other suitable computing device. The client device 210 may be configured to run a client program such as a web browser that can access the one or more functions or services provided by the application server 214. Moreover, the client device 210 may access information or other content stored at the application server 214 or the database server 216. The client devices 210 may be connected to one or more printing devices 226 for printing offer documents corresponding to consumer-selected offers made available online by one or more offer providers 228 via the offer management system 224.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A digital offer template for use in generating printable offer documents, the offer template comprising:
a canvas content layer including attributes common to a plurality of offer documents;
an offer content layer including a number of offer-specific content elements; and
a reference content layer including a number of print-specific content elements configured to uniquely identify each printed offer document, wherein the reference content layer having print-specific information is merged with the canvas content layer and the offer content layer at a time of printing to generate a printable offer document.

2. The digital offer template of claim 1, wherein at least one of the offer content layer and the reference content layer is configured to contain redundant offer information in both encrypted form and unencrypted form.

3. The digital offer template of claim 1, wherein at least one of the canvas content layer, the offer content layer and the reference content layer includes a watermark comprising a plurality of watermark elements, at least one watermark element containing offer data relating to the printable offer document embedded into a feature of the watermark element.

4. The digital offer template of claim 1, wherein the canvas content layer includes an offer border comprising a plurality of border elements forming a pattern having variations indiscernible to a naked human eye.

5. The digital offer template of claim 4, wherein the variations include at least one of: a) a variation to a dimension of one or more border element; and b) a variation to a distance between at least two border elements.

6. The digital offer template of claim 1, wherein at least one of the canvas content layer, the offer content layer and the reference content layer includes a content field having at least a first indicia and a second indicia, the first indicia including a plurality of alphanumeric characters, the second indicia including at least one indiscernible attribute applied to the first indicia.

7. The digital offer template of claim 6, wherein the at least one indiscernible attribute is selected from the following: (a) a variation in spacing between alphanumeric characters; (b) a variation in font type between alphanumeric characters; and (c) a variation in font size between alphanumeric characters.

8. The digital offer template of claim 1, wherein the offer-specific content elements include an offer ID that identifies a particular offer generically and the print-specific information includes a unique offer identification number that uniquely identifies each printed offer document.

9. The digital offer template of claim 8, wherein one of the offer content layer and the reference content layer includes a security strip content field containing both offer-specific information and print-specific information.

10. The digital offer template of claim 9, wherein the security strip content field is configured to contain at least the offer ID and the unique offer identification number.

11. A method for distributing printable offers comprising:
formatting offer data for display on an electronic display device;
storing a digital offer template for use in generating a plurality of printable offer documents, the digital offer template including:
a canvas content layer including attributes common to the plurality of printable offer documents;
an offer content layer including offer-specific content based on the offer data; and
a reference content layer including a number of print-specific content elements for uniquely identifying each printed offer document;
receiving input from a client device indicative of a request to print an offer document corresponding to the offer data;
inserting print-specific content into the reference content layer based on the input;
generating a printable offer document in response to the input by merging the reference content layer with the canvas content layer and the offer content layer; and
outputting the printable offer document for printing on a printing device in communication with the client device.

12. The method of claim 11, wherein at least one of the offer content layer and the reference content layer is configured to contain redundant offer information in both encrypted form and unencrypted form.

13. The method of claim 11, wherein at least one of the canvas content layer, the offer content layer and the reference content layer includes a watermark comprising a plurality of watermark elements, at least one watermark element containing offer data relating to the printable offer document embedded into a feature of the watermark element.

14. The method of claim 11, wherein the canvas content layer includes an offer border comprising a plurality of border elements forming a pattern having variations indiscernible to a naked human eye.

15. The method of claim 14, wherein the variations include at least one of: a) a variation to a dimension of one or more border element; and b) a variation to a distance between at least two border elements.

16. The method of claim 11, wherein at least one of the canvas content layer, the offer content layer and the reference content layer includes a content field having at least a first indicia and a second indicia, the first indicia including a plurality of alphanumeric characters, the second indicia including at least one indiscernible attribute applied to the first indicia.

17. The method of claim 16, wherein the at least one indiscernible attribute is selected from the following: (a) a variation in spacing between alphanumeric characters; (b) a variation in font type between alphanumeric characters; and (c) a variation in font size between alphanumeric characters.

18. The method of claim 11, wherein the offer-specific content includes an offer ID that identifies a particular offer generically and the print-specific content includes a unique offer identification number that uniquely identifies each printed offer document.

19. An offer distribution system comprising:
an offer management system including at least one server and at least one database in communication with each other, the offer management system being connectable to a network for communicating with a plurality of client devices;
wherein the at least one server includes a microprocessor configured to:
format offer data for display on an electronic display device;
store a digital offer template for use in generating a plurality of printable offer documents, the digital offer template including:
a canvas content layer including attributes common to the plurality of printable offer documents;
an offer content layer including offer-specific content based on the offer data; and
a reference content layer including a number of print-specific content elements for uniquely identifying each printed offer document;
receive input from a client device indicative of a request to print an offer document corresponding to the offer data; and
generate a printable offer document based on the input by merging the reference content layer including print-specific content with the canvas content layer and the offer content layer.

20. The system of claim 19, wherein at least one of the offer content layer and the reference content layer contains redundant offer information in both encrypted form and unencrypted form.
